(19) United States
(12) Patent Application Publication
(10) Pub. No.: US 2026/0043997 A1
(43) Pub. Date: Feb. 12, 2026

(54) PRISM MOTOR, METHOD FOR DETECTING A ROTATION ANGLE OF A PRISM MOTOR, AND CAMERA DEVICE

(71) Applicant: Chipsemi Semiconductor (NingBo) Co., Ltd., Ningbo (CN)

(72) Inventors: Yulin ZHANG, Ningbo (CN); Yaoguo ZHANG, Ningbo (CN); Bo XIA, Ningbo (CN); Bo NIE, Ningbo (CN); Haifeng SHEN, Ningbo (CN)

(21) Appl. No.: 19/332,022

(22) Filed: Sep. 17, 2025

Related U.S. Application Data
(63) Continuation of application No. PCT/CN2025/099068, filed on Jun. 4, 2025.

(30) Foreign Application Priority Data
Aug. 12, 2024 (CN) 202411103530.9

(51) Int. Cl. G02B 26/08; G02B 27/64; H04N 23/55; H04N 23/68

(52) U.S. Cl. CPC G02B 26/0891; G02B 27/646; H04N 23/55; H04N 23/685

(57) ABSTRACT

A prism motor, a method for detecting a rotation angle of a prism motor, and a camera device are provided. The prism motor includes: a base, a prism carrier, a first electrode plate, a plurality of second electrode plates, and a floating electrode plate. The base includes a base plate, the prism carrier is disposed above the base plate and configured to carry a prism, the prism carrier is rotatable relative to the base about each of a first rotation axis and a second rotation axis, the first rotation axis and the second rotation axis are both parallel to a surface of the base plate, and an intersection point of the first rotation axis and the second rotation axis is a rotation center. The first electrode plate is located on a surface of the base.

### CROSS REFERENCE TO RELATED APPLICATIONS

This application is a continuation of PCT Patent Application No. PCT/CN2025/099068, entitled “PRISM MOTOR, METHOD FOR DETECTING A ROTATION ANGLE OF A PRISM MOTOR, AND CAMERA DEVICE,” filed Jun. 4, 2025, which claims priority to Chinese Patent Application No. CN202411103530.9, entitled “PRISM MOTOR, METHOD FOR DETECTING A ROTATION ANGLE OF A PRISM MOTOR, AND CAMERA DEVICE,” filed on Aug. 12, 2024, which is incorporated by reference herein in its entirety.

### TECHNICAL FIELD

The various embodiments described in this document relate in general to the technical field of electronic products, and more specifically to a prism motor, a method for detecting a rotation angle of a prism motor, and a camera device.

### BACKGROUND

With the development of technology, many contemporary electronic devices such as tablet computers or smartphones are equipped with lens modules and have camera or video functions. Lenses can be broadly categorized into wide-angle lenses with short focal lengths and telephoto lenses with long focal lengths. However, placing a lens with a long focal length in an optical module increases the thickness of the electronic device, making it difficult to meet the requirements for thinner and slimmer form factors in mobile terminal devices. In the related art, a periscope design is typically adopted, where an optical path is arranged horizontally and a deflecting prism is added to deflect the optical path by 90 degrees, allowing the entire optical system to lie flat to reduce the overall height of the entire optical system.

A periscope lens driving apparatus comprises a reflection module (a prism motor) and a lens module (a periscope motor). The reflection module reflects imaging light rays by 90 degrees into the lens module, and then the lens module performs focusing and imaging. For a shake prevention solution for the periscope module, shake prevention in two directions are respectively or jointly handled by the reflection module and the lens module.

However, the prism motor has the problem of low shake prevention accuracy.

### SUMMARY

Embodiments of the present disclosure provide a prism motor, a method for detecting a rotation angle of a prism motor, and a camera device, which is at least beneficial for improving the shake prevention accuracy of the prism motor.

According to some embodiments, one aspect of the present disclosure provides a prism motor, including: a base, a prism carrier, a first electrode plate, a plurality of second electrode plates, and a floating electrode plate. The base includes a base plate. The prism carrier is disposed above the base plate and configured to carry a prism, where the prism carrier is rotatable relative to the base about each of a first rotation axis and a second rotation axis, the first rotation axis and the second rotation axis are both parallel to a surface of the base plate, and an intersection point of the first rotation axis and the second rotation axis is a rotation center. The first electrode plate is located on the surface of the base plate, where an orthographic projection of a geometric center of the first electrode plate on the base plate coincides with an orthographic projection of the rotation center on the base plate. The plurality of second electrode plates are arranged at intervals on the surface of the base plate and spaced apart from the first electrode plate, where at least two second electrode plates of the plurality of second electrode plates are symmetrically arranged about a plane in which the geometric center of the first electrode plate and the first rotation axis are located. The floating electrode plate is located on a bottom surface of the prism carrier and disposed opposite to each of the first electrode plate and the plurality of second electrode plates.

In some embodiments, at least two second electrode plates of the plurality of second electrode plates are symmetrically arranged about a plane in which the geometric center of the first electrode plate and the second rotation axis Y are located.

In some embodiments, the first electrode plate includes a central electrode plate and a plurality of extension electrode plates. An orthographic projection of a geometric center of the central electrode plate on the base plate coincides with an orthographic projection of the rotation center on the base plate. The plurality of extension electrode plates are located around the central electrode plate and centrally symmetrically arranged about the geometric center of the central electrode plate, where each of the plurality of extension electrode plates is electrically connected to the central electrode plate. Along a circumferential direction of the central electrode plate, a respective second electrode plate of the plurality of second electrode plates is between adjacent extension electrode plates of the plurality of extension electrode plates.

In some embodiments, the first electrode plate includes a through-hole penetrating the first electrode plate in a thickness direction, an orthographic projection of a geometric center of the through-hole on the surface of the base plate coincides with the orthographic projection of the rotation center on the base plate, and the plurality of second electrode plates are located within the through-hole.

In some embodiments, the plurality of second electrode plates are located at a periphery of the first electrode plate.

In some embodiments, an orthographic projection of each of the first electrode plate and the plurality of second electrode plates on the surface of the base plate is within an orthographic projection of the floating electrode plate on the surface of the base plate.

In some embodiments, the floating electrode plate includes a plurality of conductive plates, the plurality of conductive plates are electrically connected to each other, and an orthographic projection of each respective conductive plate of the plurality of conductive plates on the surface of the base plate covers the first electrode plate or one respective second electrode plate of the plurality of second electrode plates.

In some embodiments, relative to an initial position where the bottom surface of the prism carrier is parallel to the base plate, an angle of rotation of the prism carrier relative to the base about the first rotation axis is less than or equal to 5°, and an angle of rotation of the prism carrier relative to the base about the second rotation axis is less than or equal to 5°.

According to some embodiments, another aspect of the present disclosure provides a method for detecting a rotation angle of a prism motor, applied to the prism motor according to the above embodiments, includes: rotating the prism carrier to an initial position where the bottom surface of the prism carrier is parallel to the base plate; rotating the prism carrier clockwise about the first rotation axis to a first target angle, during rotation, acquiring a plurality of first capacitance values between each respective second electrode plate and the first electrode plate at a plurality of first rotation angles, and fitting a first curve graph with the plurality of first rotation angles and the plurality of first capacitance values; rotating the prism carrier back to the initial position; rotating the prism carrier counterclockwise about the first rotation axis to a second target angle, during rotation, acquiring a plurality of second capacitance values between the respective second electrode plate and the first electrode plate at a plurality of second rotation angles, and fitting a second curve graph with the plurality of second rotation angles and the plurality of second capacitance values; combining the first curve graph and the second curve graph to obtain a capacitance-angle curve graph, the capacitance-angle curve graph characterizing a relationship between capacitance values between the respective second electrode plate and the first electrode plate and different angles to which the prism carrier is rotated about the first rotation axis relative to the base; acquiring a real-time capacitance between the first electrode plate and the respective second electrode plate; and inputting the real-time capacitance into the capacitance-angle curve graph to obtain a rotation angle of the prism carrier about the first rotation axis relative to the base.

According to some embodiments, yet another aspect of the present disclosure provides a camera device, including the prism motor according to the above embodiments, a prism, a lens, and a photosensitive chip. The prism is disposed on the prism carrier, where an incident light direction of the prism is perpendicular to the surface of the base plate, and a reflected light direction of the prism is parallel to the first rotation axis. The lens has a focusing direction that coincides with the reflected light direction of the prism. The photosensitive chip is located on a side of the lens away from the prism and configured to receive reflected light passing through the lens.

### BRIEF DESCRIPTION OF THE DRAWINGS

One or more embodiments are exemplarily described with reference to the corresponding figures in the accompanying drawings, and the descriptions are not to be construed as limiting the embodiments. Elements in the accompanying drawings that have same reference numerals are represented as similar elements, and unless otherwise particularly stated, the figures in the accompanying drawings are not drawn to scale.

FIG. 1 is a schematic diagram of an overall structure of a prism motor according to an embodiment of the present disclosure.

FIG. 2 is a schematic cross-sectional view of a prism motor along a first rotation axis according to an embodiment of the present disclosure.

FIG. 3 is a top view of a first plate and a second plate according to an embodiment of the present disclosure.

FIG. 4 is a top view of a first plate and a second plate according to another embodiment of the present disclosure.

FIG. 5A and FIG. 5B are top views of a first plate and a second plate according to yet another embodiment of the present disclosure.

FIG. 6 is a top view corresponding to a first plate, a second plate, and a floating plate according to an embodiment of the present disclosure.

FIG. 7 is a top view corresponding to a first plate, a second plate, and a floating plate according to another embodiment of the present disclosure.

FIG. 8 is a schematic diagram of a position of a point R in a Cartesian coordinate system according to an embodiment of the present disclosure.

FIG. 9 is a simulation curve of a prism carrier rotating about the first rotation axis.

FIG. 10 is a simulation curve of the prism carrier rotating about the first rotation axis in the case where the prism carrier is rotated by ±1° about a second rotation axis relative to a base.

FIG. 11 is a simulation curve of the prism carrier rotating about the first rotation axis in the case where the prism carrier is rotated about the second rotation axis at intervals of 0.5°.

FIG. 12 is a schematic diagram of a structure of a camera device according to an embodiment of the present disclosure.

### DETAILED DESCRIPTION OF THE EMBODIMENTS

As known from the background part, the prism motor has the problem of low shake prevention accuracy.

The prism motor generally includes a prism carrier and a base. The prism carrier is used to carry a prism. The base and the prism carrier are connected to each other by an elastic sheet so that the prism carrier is suspended above the base. The prism motor is also provided with a first driving assembly and a second driving assembly. The first driving assembly can drive the prism carrier to rotate relative to the base about a first horizontal direction. The second driving assembly can drive the prism carrier to rotate relative to the base about a second horizontal direction. An intersection point of the first horizontal direction and the second horizontal direction is a rotation center of the prism motor. During use of the prism motor, shaking inevitably occurs due to operations, causing the prism carrier to fail to align with the lens. The shaking displacement of the prism carrier relative to the base can be offset by the first driving assembly and the second driving assembly, thereby achieving shake prevention. In the related art, a method of oppositely arranging a transmitting electrode plate and a receiving electrode plate is typically adopted, where the transmitting electrode plate is disposed on the base, and the receiving electrode plate is disposed on the prism carrier. When the prism carrier rotates relative to the base, a capacitance between the transmitting electrode plate and the receiving electrode plate changes. Position detection of the prism carrier is achieved based on the change in capacitance. However, the rotation of the prism carrier relative to the base does not lead to a simple change in electrode plate area or electrode plate distance. Therefore, the capacitance change between the transmitting electrode plate and the receiving electrode plate is in not a simple linear relationship. This results in an inability to accurately obtain the relationship between a single capacitance change and the position of the prism carrier, thereby reducing the shake prevention accuracy of the prism motor.

Embodiments of the present disclosure provide a prism motor, a method for detecting a rotation angle of a prism motor, and a camera device, which is at least beneficial for improving the shake prevention accuracy of the prism motor.

In the description of the embodiments of the present disclosure, the technical terms “first” “second” and the like are only used to distinguish different objects and cannot be understood as indicating or implying relative importance or implicitly indicating the number, specific order, or primary and secondary relationship of the indicated technical features. In the description of the embodiments of the present disclosure, “a plurality of” means at least two, unless otherwise specified.

Reference herein to “embodiment” means that a particular feature, structure, or characteristic described in connection with the embodiment may be included in at least one embodiment of the present disclosure. The appearances of this phrase in various places in the specification are not necessarily all referring to the same embodiment, nor are separate or alternative embodiments that are mutually exclusive with other embodiments. It is explicitly and implicitly understood by those skilled in the art that the embodiments described herein may be combined with other embodiments.

In the description of the embodiments of the present disclosure, orientation or positional relationship indicated by technical terms “center”, “transverse”, “longitudinal”, “length”, “width”, “thickness”, “up”, “down”, “front”, “rear”, “left”, “right”, “vertical”, “horizontal”, “top”, “bottom”, “inside” “outside”, “clockwise”, “counterclockwise”, “axial”, “radial”, “circumferential” and the like are orientations or positional relationships based on those shown in the accompanying drawings, which are intended only to facilitate the description of embodiments of the present disclosure and to simplify the description, and are not intended to indicate or imply that the device or element referred to must have a particular orientation, be constructed and operated with a particular orientation, and therefore are not to be construed as a limitation of the embodiments of the present disclosure.

In the description of the embodiments of the present disclosure, when a component “includes” another component, unless otherwise stated, other components are not excluded, and other components may be further included in the component.

The following describes the embodiments of the present disclosure in detail with reference to the accompanying drawings. However, a person of ordinary skill in the art may understand that in the embodiments of the present disclosure, many technical details are provided to make readers better understand the embodiments of the present disclosure. However, even without these technical details and various changes and modifications based on the following embodiments, the technical solutions claimed in the embodiments of the present disclosure can be implemented.

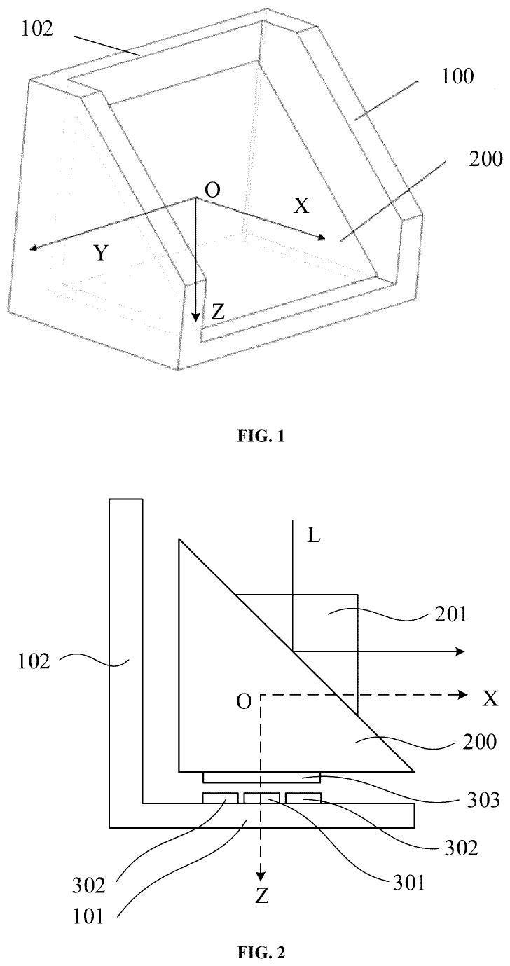

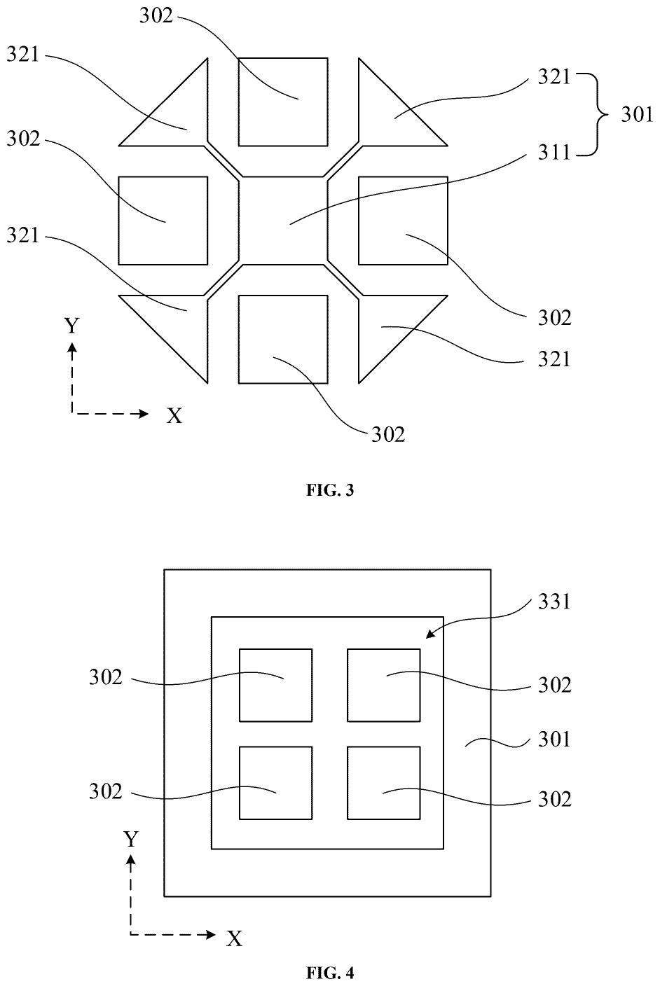

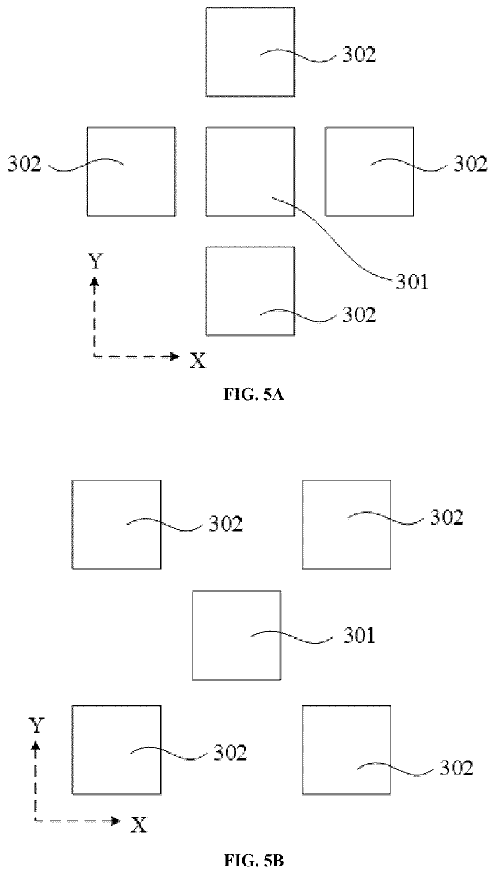

FIG. 1 is a schematic diagram of an overall structure of a prism motor according to an embodiment of the present disclosure. FIG. 2 is a schematic cross-sectional view of a prism motor along a first rotation axis according to an embodiment of the present disclosure. FIG. 3 is a top view of a first plate and a second plate according to an embodiment of the present disclosure. FIG. 4 is a top view of another first plate and second plate according to an embodiment of the present disclosure. FIG. 5A and FIG. 5B are top views of yet another first plate and second plate according to an embodiment of the present disclosure.

Referring to FIGS. 1 to 5, according to some embodiments of the present disclosure, an embodiment of the present disclosure provides a prism motor, including a base 100 and a prism carrier 200 as shown in FIGS. 1 and 2. The base 100 includes a base plate 101. The prism carrier 200 is disposed above the base plate 101, and is configured to carry a prism 201. The prism carrier 200 is rotatable relative to the base 100 about a first rotation axis X, and is also rotatable relative to the base 100 about a second rotation axis Y. The first rotation axis X and the second rotation axis Y are both parallel to a surface of the base plate 101. An intersection point of the first rotation axis X and the second rotation axis Y is a rotation center O. The prism motor further includes a first electrode plate 301, a plurality of second electrode plates 302 arranged at intervals, and a floating electrode plate 303. The first electrode plate 301 and the second electrode plates 302 are both located on a surface of the base 100. An orthographic projection of a geometric center of the first electrode plate 301 on the base plate 101 coincides with an orthographic projection of the rotation center O on the base plate 101. The second electrode plates 302 are spaced apart from the first electrode plate 301. Referring to FIGS. 3 to 5, at least two second electrode plates 302 are symmetrically arranged about a plane in which the geometric center of the first electrode plate 301 and the first rotation axis X are located. The floating electrode plate 303 is located on a bottom surface of the prism carrier 200, and is disposed opposite to each of the first electrode plate 301 and the second electrode plates 302.

In the prism motor according to the embodiments of the present disclosure, the prism carrier 200 is rotatable relative to the base 100 about the first rotation axis X or the second rotation axis Y, thereby driving the prism 201 carried on the prism carrier 200 to rotate about the first rotation axis X or the second rotation axis Y. During use of the prism motor, if shaking of an electronic device equipped with the prism motor causes the prism carrier 200 to shake, the prism carrier 200 can be driven by a driving assembly in the prism motor to rotate in an opposite direction to offset displacement caused by shaking. A first electrode plate 301 and a plurality of spaced second electrode plates 302 are disposed on the base plate 101 of the prism motor, and a floating electrode plate 303 is disposed a bottom surface of the prism carrier 200. The first electrode plate 301 and the second electrode plates 302 are configured to connect to a detection circuit. A capacitance (i.e., a first capacitance) can be formed between the first electrode plate 301 and the floating electrode plate 303. A capacitance (i.e., a second capacitance) can be formed between a single second electrode plate 302 and the floating electrode plate 303. A capacitance value between the single second electrode plate and the first electrode plate is a series capacitance value of the first capacitance and the second capacitance. The orthographic projection of the geometric center of the first electrode plate 301 on the base plate 101 coincides with the orthographic projection of the rotation center O on the base plate 101. At least two second electrode plates 302 are symmetrically arranged about the plane in which the geometric center of the first electrode plate 301 and the first rotation axis X are located. Regardless of whether the prism carrier 200 rotates clockwise or counterclockwise about the first rotation axis X relative to the base 100, at least two capacitance values correspond to each rotation angle. Based on multiple capacitance values corresponding to different rotation angles, a relationship between a rotation angle of the prism carrier 200 rotating about the first rotation axis X and changes in multiple capacitances can be obtained. Then, during use of the prism motor, the rotation angle of the prism carrier 200 can be inversely calculated based on corresponding multiple capacitance values. In this way, a position state of the prism carrier 200 can be accurately acquired, enabling the driving assembly to accurately drive rotation of the prism carrier 200 to offset displacement caused by shaking according to the corresponding position state, thereby improving shake prevention accuracy. Additionally, the floating electrode plate 303 does not need to connect to the detection circuit, preventing instability of the detection circuit due to shaking of the prism carrier 200. This facilitates improving accuracy in obtaining capacitance values between the first electrode plate 301 and the second electrode plates 302, further enhancing calculation accuracy of the rotation angle of the prism carrier 200, and thus improving shake prevention accuracy.

In this embodiment, the first rotation axis X is perpendicular to the second rotation axis Y, that is, an angle between the first rotation axis X and the second rotation axis Y is 90°. In some embodiments, the angle between the first rotation axis and the second rotation axis may be 30°, 45°, or 60°.

In some embodiments, referring to FIG. 2, the base 100 further includes a side plate 102. The side plate 102 is perpendicularly disposed to the base plate 101. The first rotation axis X is perpendicular to a surface of the side plate 102. Referring to FIGS. 1 and 2, an optical path direction L of the prism 201 is parallel to a Z-axis direction. After reflection by the prism 201, the optical path direction L is refracted to be parallel to the first rotation axis X.

In some embodiments, a coil assembly may be disposed on the side plate. A magnet assembly may be disposed on a surface of the prism carrier facing the side plate. The magnet assembly and the coil assembly constitute a driving assembly. The coil assembly generates a magnetic field when energized. An interaction force is generated between this magnetic field and a magnetic field of the magnet assembly to cause rotation of the prism carrier.

Referring to FIG. 1 to FIG. 5B, in some embodiments, at least two second electrode plates 302 are symmetrically arranged about a plane in which the geometric center of the first electrode plate 301 and the second rotation axis Y are located. In this way, one second electrode plate 302 and the first electrode plate 301 form a capacitance (i.e., a third capacitance), and another second electrode plate 302 and the first electrode plate 301 form a capacitance (i.e., a fourth capacitance). Regardless of whether the prism carrier 200 rotates clockwise or counterclockwise about the second rotation axis Y relative to the base 100, at least two capacitance values correspond to each rotation angle. Based on multiple capacitance values corresponding to different angles, a relationship between a rotation angle of the prism carrier 200 rotating about the second rotation axis Y and changes in multiple capacitances can be obtained. During use of the prism motor, the rotation angle of the prism carrier 200 can be inversely calculated based on corresponding multiple capacitance values. In this way, a position state of the prism carrier 200 can be accurately acquired, enabling the driving assembly to accurately drive rotation of the prism carrier 200 to offset displacement caused by shaking according to the corresponding position state, thereby improving shake prevention accuracy. By combining multiple capacitance change curves corresponding to rotation of the prism carrier 200 about the first rotation axis X to different angles and multiple capacitance change curves corresponding to rotation of the prism carrier 200 about the second rotation axis Y to different angles, a real-time position state of the prism carrier 200 in spatial rotation can be obtained, thereby achieving dual-axis high-precision shake prevention for the prism motor.

Referring to FIGS. 1 to 3, in some embodiments, the first electrode plate 301 includes: a central electrode plate 311 and a plurality of extension electrode plates 321. An orthographic projection of a geometric center of the central electrode plate 311 on the base plate 101 coincides with the orthographic projection of the rotation center O on the base plate 101. The plurality of extension electrode plates 321 are disposed around the central electrode plate 311 and are centrally symmetrically arranged about the geometric center of the central electrode plate 311. Each extension electrode plate 321 is electrically connected to the central electrode plate 311. Along a circumferential direction of the central electrode plate 311, a respective second electrode plate 302 is disposed between adjacent extension electrode plates 321.

In some embodiments, the central electrode plate 311 and the extension electrode plates 321 may be an integrally formed structure. Alternatively, in some embodiments, the central electrode plate 311 and the extension electrode plates 321 may be independent of each other and connected to each other by electrical connection lines.

Referring to FIGS. 1 to 2 and FIG. 4, in some embodiments, the first electrode plate 301 includes a through-hole 331 penetrating the first electrode plate 301 in a thickness direction. An orthographic projection of a geometric center of the through-hole 331 on a surface of the base 100 coincides with an orthographic projection of the rotation center O on the base 100. The second electrode plates 302 are located in the through-hole 331.

Referring to FIGS. 1 to 2 and FIG. 5A or FIG. 5B, in some embodiments, the second electrode plates 302 are located at a periphery of the first electrode plate 301.

In some embodiments, referring to FIGS. 1 to 5B, the second electrode plates 302 are centrally symmetrically arranged about the geometric center of the first electrode plate 301. Thus, a change trend of capacitance values of the first capacitance corresponding to clockwise rotation of the prism carrier 200 about the first rotation axis X relative to the base 100 is the same as a change trend of capacitance values of the first capacitance corresponding to counterclockwise rotation of the prism carrier 200 about the first rotation axis X relative to the base 100, and a change trend of capacitance values of a second capacitance (between the first electrode plate 301 and one of two symmetrically arranged second electrode plates 302) during clockwise rotation of the prism carrier 200 about the first rotation axis X relative to the base 100 is the same as a change trend of capacitance values of another second capacitance (between the first electrode plate 301 and the other of the two symmetrically arranged second electrode plates 302) during counterclockwise rotation of the prism carrier 200 about the first rotation axis X relative to the base 100. Similarly, a change trend of capacitance values of the third capacitance corresponding to clockwise rotation of the prism carrier 200 about the second rotation axis Y relative to the base 100 is the same as a change trend of capacitance values of the fourth capacitance corresponding to counterclockwise rotation of the prism carrier 200 about the second rotation axis Y relative to the base 100, and a change trend of capacitance values of the fourth capacitance corresponding to clockwise rotation of the prism carrier 200 about the second rotation axis Y relative to the base 100 is the same as a change trend of capacitance values of the third capacitance corresponding to counterclockwise rotation of the prism carrier 200 about the second rotation axis Y relative to the base 100. This facilitates calculation of a correspondence between a position state of the prism carrier 200 and multiple capacitance values.

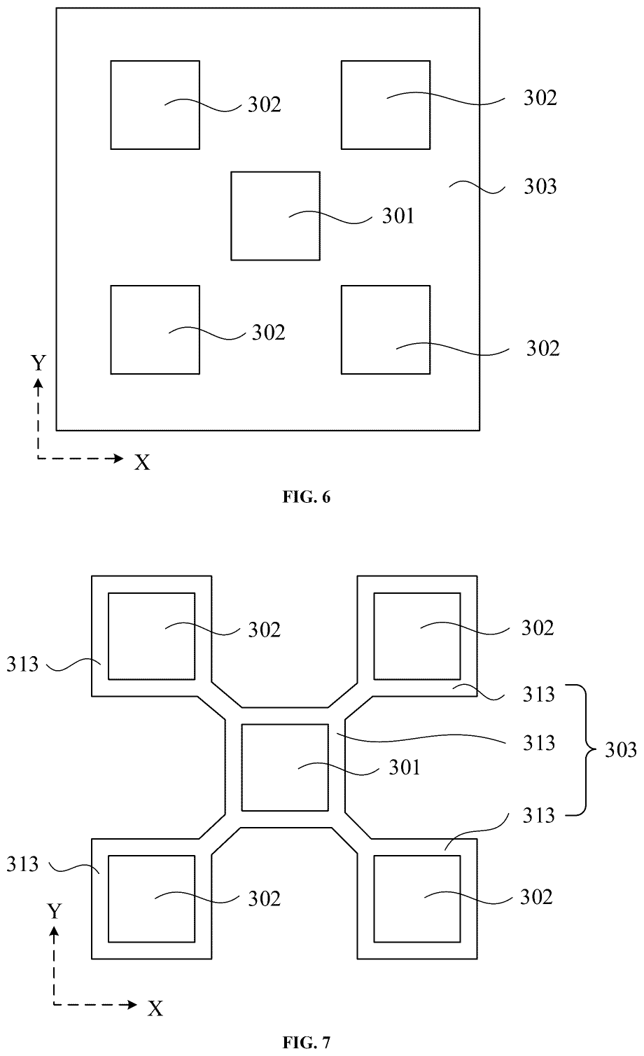

FIG. 6 is a top view of a first electrode plate, a second electrode plate, and a floating electrode plate according to an embodiment of the present disclosure. FIG. 7 is a top view of a first electrode plate, a second electrode plate, and a floating electrode plate according to another embodiment of the present disclosure. For illustrative purpose, the floating electrode plate 303 is shown in a transparent state in FIGS. 6 and 7.

Referring to FIGS. 1, 2, 6, and 7, in some embodiments, during rotation of the prism carrier 200 relative to the base 100 about the first rotation axis X or the second rotation axis Y, an orthographic projection of the first electrode plate 301 on the surface of the base plate 101 is always within an orthographic projection of the floating electrode plate 303 on the surface of the base plate 101, and orthographic projections of the second electrode plates 302 on the surface of the base plate 101 are always within the orthographic projection of the floating electrode plate 303 on the surface of the base plate 101. Thus, during rotation of the floating electrode plate 303 driven by rotation of the prism carrier 200, an effective arca of a capacitance formed between the first electrode plate 301 and the floating electrode plate 303 is always an area of the first electrode plate 301, and an effective area of a capacitance formed between the second electrode plate 302 and the floating electrode plate 303 is always an area of the second electrode plate 302, to avoid fluctuation in capacitance change caused by an abrupt change in the effective area between the floating electrode plate 303 and the first electrode plate 301 or the second electrode plate 302. The effective area refers to an actual area between two electrode plates available for charge storage.

Referring to FIG. 6, in some embodiments, the floating electrode plate 303 may be an integral planar structure.

Referring to FIGS. 2 and 7, in some embodiments, the floating electrode plate 303 may include a plurality of conductive plates 313. The plurality of conductive plates 313 are electrically connected to each other. An orthographic projection of each conductive plate 313 on the surface of the base plate 101 covers the first electrode plate 301 or one second electrode plate 302. Thus, shapes of the floating electrode plates 303 can be designed according to positions and shapes of the first electrode plate 301 and second electrode plates 302.

In some embodiments, the plurality of conductive plates 313 may be in electrical contact with each other, that is, the plurality of conductive plates 313 are an integrally formed structure. Alternatively, in some embodiments, the plurality of conductive plates 313 may be independent of each other and connected to each other by electrical connection lines.

In some embodiments, relative to an initial position where the bottom surface of the prism carrier 200 is parallel to the base plate 101, an angle of rotation of the prism carrier 200 relative to the base 100 about the first rotation axis X is less than or equal to 5°, for example, 1°, 1.4°, 2°, 2.5°, 3°, 3.3°, 4°, 4.8°, or 5°; and an angle of rotation of the prism carrier 200 relative to the base 100 about the second rotation axis Y is less than or equal to 5°, for example, 1°, 1.4°, 2°, 2.5°, 3°, 3.3°, 4°, 4.8°, or 5°. It should be noted that the rotation of the prism carrier 200 relative to the base 100 about the first rotation axis X may be in a clockwise direction or a counterclockwise direction, and the rotation of the prism carrier 200 relative to the base 100 about the second rotation axis Y may be in a clockwise direction or a counterclockwise direction.

In the prism motor according to the embodiments of the present disclosure, the prism carrier 200 is rotatable relative to the base 100 about the first rotation axis X or the second rotation axis Y, thereby driving the prism 201 carried on the prism carrier 200 to rotate about the first rotation axis X or the second rotation axis Y. During use of the prism motor, if shaking of an electronic device equipped with the prism motor causes the prism carrier 200 to shake, the prism carrier 200 can be driven by a driving assembly in the prism motor to rotate in an opposite direction to offset displacement caused by shaking. A first electrode plate 301 and a plurality of spaced second electrode plates 302 are disposed on the base plate 101 of the prism motor, and a floating electrode plate 303 is disposed a bottom surface of the prism carrier 200. The first electrode plate 301 and the second electrode plates 302 are configured to connect to a detection circuit. A capacitance (i.e., a first capacitance) can be formed between the first electrode plate 301 and the floating electrode plate 303. A capacitance (i.e., a second capacitance) can be formed between a single second electrode plate 302 and the floating electrode plate 303. A capacitance value between the single second electrode plate and the first electrode plate is a series capacitance value of the first capacitance and the second capacitance. The orthographic projection of the geometric center of the first electrode plate 301 on the base plate 101 coincides with the orthographic projection of the rotation center O on the base plate 101. At least two second electrode plates 302 are symmetrically arranged about the plane in which the geometric center of the first electrode plate 301 and the first rotation axis X are located. Regardless of whether the prism carrier 200 rotates clockwise or counterclockwise about the first rotation axis X relative to the base 100, at least two capacitance values correspond to cach rotation angle. Based on multiple capacitance values corresponding to different rotation angles, a relationship between a rotation angle of the prism carrier 200 rotating about the first rotation axis X and changes in multiple capacitances can be obtained. Then, during use of the prism motor, the rotation angle of the prism carrier 200 can be inversely calculated based on corresponding multiple capacitance values. In this way, a position state of the prism carrier 200 can be accurately acquired, enabling the driving assembly to precisely drive rotation of the prism carrier 200 to offset displacement caused by shaking according to the corresponding position state, thereby improving shake prevention accuracy. Additionally, the floating electrode plate 303 does not need to connect to the detection circuit, preventing instability of the detection circuit due to shaking of the prism carrier 200. This facilitates improving accuracy in obtaining capacitance values between the first electrode plate 301 and the second electrode plates 302, further enhancing calculation accuracy of the rotation angle of the prism carrier 200, and thus improving shake prevention accuracy.

Correspondingly, another embodiment of the present disclosure provides a method for detecting a rotation angle of a prism motor, which is applied to the prism motor in the above embodiments to improve shake prevention accuracy of the prism motor. Parts identical or corresponding to those in the previous embodiments can be referred to the corresponding description in the foregoing embodiments, which is not repeated in detail below.

The method for detecting the rotation angle of the prism motor includes: rotating the prism carrier to an initial position where the bottom surface of the prism carrier is parallel to the base plate; rotating the prism carrier clockwise about the first rotation axis to a first target angle, during rotation, acquiring a plurality of first capacitance values between each respective second electrode plate and the first electrode plate at a plurality of rotation angles, and fitting a first curve graph with the plurality of rotation angles and the plurality of first capacitance values; rotating the prism carrier back to the initial position; rotating the prism carrier counterclockwise about the first rotation axis to a second target angle, during rotation, acquiring a plurality of second capacitance values between the respective second electrode plate and the first electrode plate at a plurality of rotation angles, and fitting a second curve graph with the plurality of rotation angles and the plurality of second capacitance values; combining the first curve graph and the second curve graph to obtain a first capacitance-angle curve graph, the first capacitance-angle curve graph characterizing a relationship between capacitance values between the respective second electrode plate and the first electrode plate and different angles to which the prism carrier is rotated about the first rotation axis relative to the base; acquiring a first real-time capacitance between the first electrode plate and the respective second electrode plate; and inputting the first real-time capacitance into the first capacitance-angle curve graph to obtain a rotation angle of the prism carrier about the first rotation axis relative to the base.

In some embodiments, in a case where at least two second electrode plates in the prism motor are symmetrically arranged about a plane in which a geometric center of the first electrode plate and the second rotation axis are located, the method further includes: before rotating the prism carrier clockwise about the first rotation axis to the first target angle, first rotating the prism carrier about the second rotation axis to a preset angle, with the preset angle unchanged, rotating the prism carrier clockwise about the first rotation axis to the first target angle, and during rotation, acquiring a plurality of third capacitance values between each respective second electrode plate and the first electrode plate at multiple rotation angles, and fitting a third curve graph with the multiple rotation angles and the plurality of third capacitance values; after rotating the prism carrier back to the initial position, before rotating the prism carrier counterclockwise about the first rotation axis to the second target angle, first rotating the prism carrier about the second rotation axis to the preset angle, with the preset angle unchanged, rotating the prism carrier counterclockwise about the first rotation axis to the second target angle, and during rotation, acquiring a plurality of fourth capacitance values between each respective second electrode plate and the first electrode plate at multiple rotation angles, and fitting a fourth curve graph with the multiple rotation angles and the plurality of fourth capacitance values; combining the third curve graph and the fourth curve graph to obtain a second capacitance-angle curve graph, the second capacitance-angle curve graph characterizing, in the case where the prism carrier is rotated about the second rotation axis relative to the base to the preset angle, a relationship between capacitance values between the respective second electrode plate and the first electrode plate and different angles to which the prism carrier is rotated about the second rotation axis relative to the base; acquiring a plurality of second real-time capacitances between the first electrode plate and each second electrode plate, and inputting the plurality of second real-time capacitances into the first capacitance-angle curve graph and the second capacitance-angle curve graph to obtain rotation angles of the prism carrier about the first rotation axis X and the second rotation axis Y relative to the base.

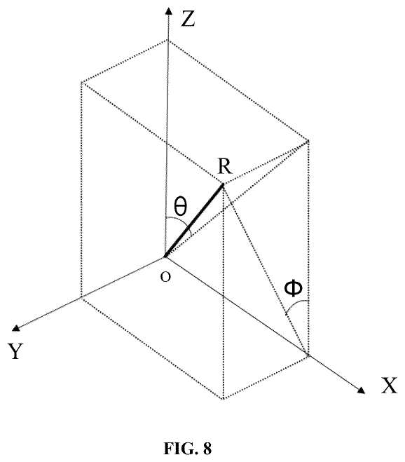

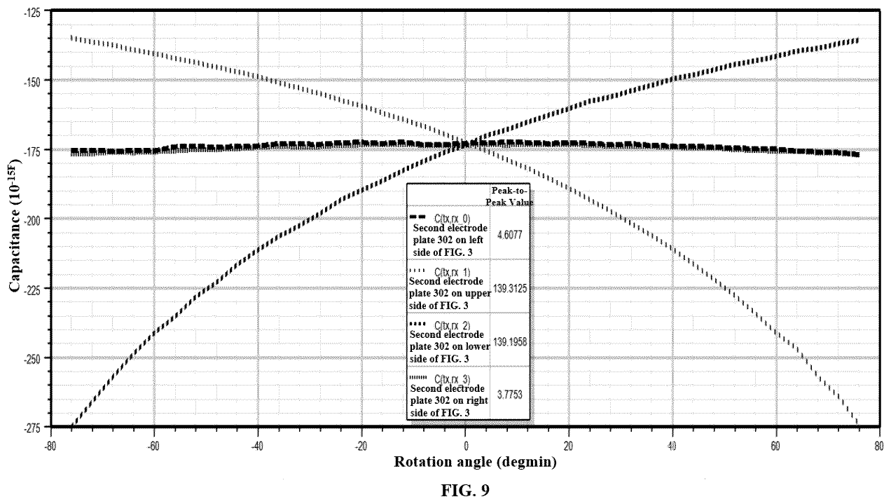

FIG. 8 is a schematic diagram of a position of a point R in a Cartesian coordinate system according to an embodiment of the present disclosure.

In the Cartesian coordinate system with the first rotation axis X, the second rotation axis Y, and a Z-axis, at an initial position, an intersection point of the floating electrode plate with the Z-axis is denoted as point R. Assuming a coordinate of any point on the floating electrode plate is (a, b, c), after the floating electrode plate is driven to any angle by rotation of the prism carrier, a radius d from that point to the rotation center O remains constant. A coordinate of the point R in space can be calculated by the following formulas: (1) a²+b²+c²=d²; (2) a/c=tanθ, and b/c=tan/φ. The coordinate of the point R is set to R (a′, b′, c′), and substituting the coordinate of point R into the above formulas yields a planar spatial equation of the floating electrode plate in the Cartesian coordinate system: a·a′+b·b′+c·c′=a²+b²+c². Thus, a distance from any point on the first electrode plate and the second electrode plate to an orthographic projection point of that point on the floating electrode plate along the Z-axis direction can be obtained. Given shapes of the first electrode plate and the second electrode plate and corresponding coordinates, a capacitance calculation formula can be expressed as: C=A* ∫∫1/[f(a, b)+gap]df (a, b). A represents a constant, f(a,b) represents a shape equation corresponding to the second electrode plate, and gap represents a distance between the floating electrode plate and the second electrode plate in the initial state.

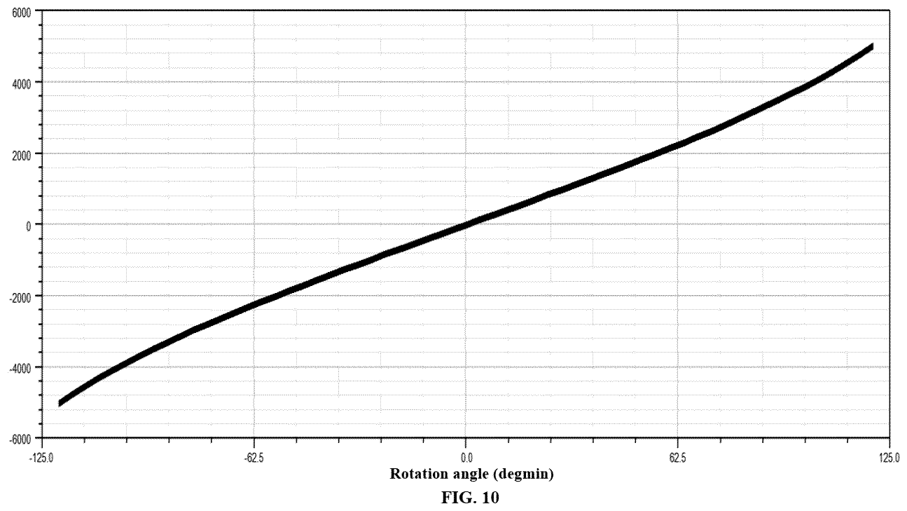

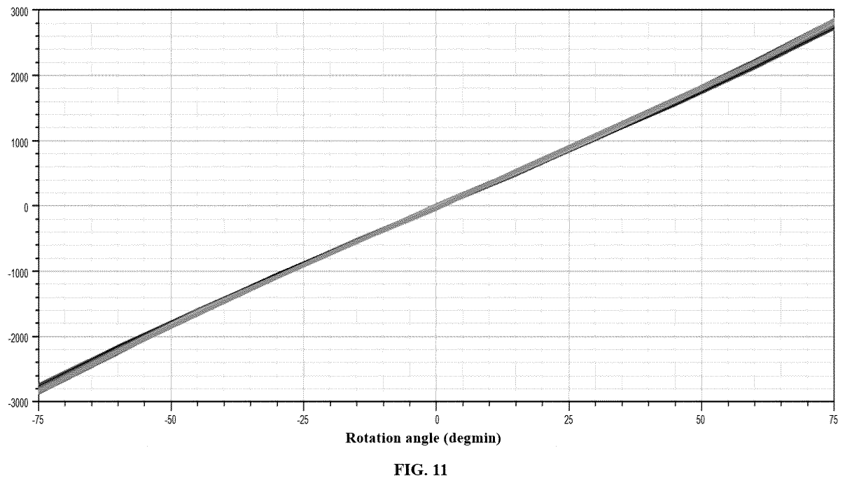

Using the first electrode plate and second electrode plates shown in FIG. 3 for simulation calculation, FIG. 9 is a simulation curve of the prism carrier rotating about the first rotation axis, FIG. 10 is a simulation curve of the prism carrier rotating about the first rotation axis in the case where the prism carrier is rotated by ±1° about the second rotation axis relative to the base, and FIG. 11 is a simulation curve of the prism carrier rotating about the first rotation axis in the case where the prism carrier is rotated about the second rotation axis at intervals of 0.5°. In FIGS. 9 to 11, an abscissa represents different rotation angles of the prism carrier about the first rotation axis X, and an ordinate represents capacitance values between the second electrode plate and the first electrode plate at corresponding rotation angles.

According to FIG. 9, it can be seen that a capacitance value between the first electrode plate and each of two second electrode plates symmetrically arranged about the plane in which the first rotation axis and the geometric center of the first electrode plate are located changes significantly, while a capacitance change between the first electrode plate and each of another two second electrode plates disposed on two sides of the first electrode plate about the first rotation axis changes slightly. By respectively processing the two sets of signals, a correspondence between rotation angles of the prism carrier rotating about the first rotation axis relative to the base and capacitance values between different second electrode plates and the first electrode plate can be obtained.

According to FIG. 10, it can be seen that the capacitance value between the second electrode plate and the first electrode plate exhibit a favorable linear relationship with the change in rotation angle, and since both the first electrode plates and the second electrode plates are centrally symmetrically distributed about the geometric center of the first electrode plate, a simulation curve of the prism carrier rotating about the first rotation axis in the case where the prism carrier rotates about the second rotation axis relative to the base by ±1° is identical to a simulation curve of the prism carrier rotating about the second rotation axis in the case where the prism carrier rotates about the first rotation axis relative to the base by ±1°.

According to FIG. 11, it can be seen that in the case where the prism carrier rotates about the second rotation axis to different angles, correspondences between rotation angles of the prism carrier rotating about the first rotation axis and capacitance values between different second electrode plates and the first electrode plate have a high degree of coincidence. By decoupling processing, a rotation angle of the prism carrier relative to the base about each of the first rotation axis and the second rotation axis can be accurately obtained, thereby facilitating formation of a closed-loop control system to precisely control a spatial position of the prism and thus improving shake prevention performance of the prism motor.

Correspondingly, another embodiment of the present disclosure further provides a camera device including the prism motor according to any of the above embodiments, which can accurately acquire a position state of the prism carrier, thereby enabling a driving assembly to accurately drive rotation of the prism carrier according to the corresponding position state to offset displacement caused by shaking, and thus improving shake prevention accuracy. Parts identical or corresponding to those in the previous embodiments can be referred to the corresponding description in the foregoing embodiments, which is not repeated in detail below.

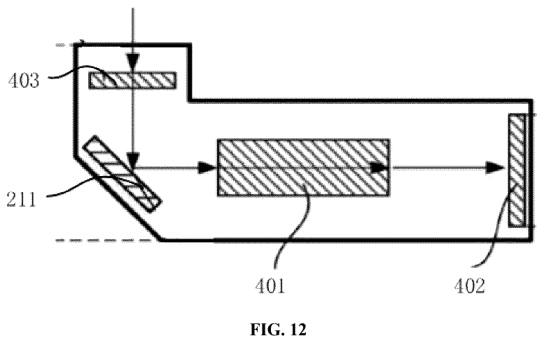

FIG. 12 is a schematic structural diagram of a camera device according to an embodiment of the present disclosure. For illustrative purposes, only a reflective surface 211 of the prism 201 is shown in FIG. 12.

Referring to FIGS. 1, 2, and 12, the camera device includes: the prism motor according to any one of the above embodiments; a prism 201 disposed on the prism carrier 200, an incident light direction of the prism 201 being perpendicular to a surface of the base plate 101, a reflected light direction of the prism 201 being parallel to the first rotation axis X; a lens 401, a focusing direction of the lens 401 coinciding with a reflected light direction of the prism 201; and a photosensitive chip 402 located on a side of the lens 401 away from the prism 201 and configured to receive reflected light passing through the lens 401.

In some embodiments, the camera device may further include a light-transmitting plate 403 configured to allow incident light to pass through and irradiate the prism 201.

A person of ordinary skill in the art shall understand that the above embodiments are merely specific and exemplary embodiments for practicing the present disclosure, and in practice, various modifications may be made to these embodiments in terms of formality and detail, without departing from the spirit and scope of the present disclosure. Various variations and modifications may be made by one skilled in the art without departing from the spirit and scope of the present disclosure. Accordingly, the protection scope of the present disclosure is subject to the appended claims.

What is claimed is:

1. A prism motor, comprising:
a base, including a base plate;
a prism carrier, disposed above the base plate and configured to carry a prism, wherein the prism carrier is rotatable relative to the base about each of a first rotation axis and a second rotation axis, the first rotation axis and the second rotation axis are both parallel to a surface of the base plate, and an intersection point of the first rotation axis and the second rotation axis is a rotation center;
a first electrode plate, located on the surface of the base plate, wherein an orthographic projection of a geometric center of the first electrode plate on the base plate coincides with an orthographic projection of the rotation center on the base plate;
a plurality of second electrode plates, arranged at intervals on the surface of the base plate and spaced apart from the first electrode plate, wherein at least two second electrode plates of the plurality of second electrode plates are symmetrically arranged about a plane in which the geometric center of the first electrode plate and the first rotation axis are located; and
a floating electrode plate, located on a bottom surface of the prism carrier and disposed opposite to each of the first electrode plate and the plurality of second electrode plates;
wherein the first electrode plate and the plurality of second electrode plates are configured to connect to a detection circuit, a first capacitor is formed between the first electrode plate and the floating electrode plate, a second capacitor is formed between each respective second electrode plate of the plurality of second electrode plates and the floating electrode plate, and a capacitance value between the respective second electrode plate and the first electrode plate is a series capacitance value of the first capacitor and the second capacitor.

2. The prism motor according to claim 1, wherein at least two second electrode plates of the plurality of second electrode plates are symmetrically arranged about a plane in which the geometric center of the first electrode plate and the second rotation axis are located.

3. The prism motor according to claim 1, wherein the first electrode plate includes:
a central electrode plate, wherein an orthographic projection of a geometric center of the central electrode plate on the base plate coincides with an orthographic projection of the rotation center on the base plate; and
a plurality of extension electrode plates, located around the central electrode plate and centrally symmetrically arranged about the geometric center of the central electrode plate, wherein each of the plurality of extension electrode plates is electrically connected to the central electrode plate;
wherein along a circumferential direction of the central electrode plate, a respective second electrode plate of the plurality of second electrode plates is between adjacent extension electrode plates of the plurality of extension electrode plates.

4. The prism motor according to claim 1, wherein the first electrode plate includes a through-hole penetrating the first electrode plate in a thickness direction, an orthographic projection of a geometric center of the through-hole on the surface of the base plate coincides with the orthographic projection of the rotation center on the base plate, and the plurality of second electrode plates are located within the through-hole.

5. The prism motor according to claim 1, wherein the plurality of second electrode plates are located at a periphery of the first electrode plate.

6. The prism motor according to claim 1, wherein an orthographic projection of each of the first electrode plate and the plurality of second electrode plates on the surface of the base plate is within an orthographic projection of the floating electrode plate on the surface of the base plate.

7. The prism motor according to claim 1, wherein the floating electrode plate includes a plurality of conductive plates, the plurality of conductive plates are electrically connected to each other, and an orthographic projection of each respective conductive plate of the plurality of conductive plates on the surface of the base plate covers the first electrode plate or one respective second electrode plate of the plurality of second electrode plates.

8. The prism motor according to claim 1, wherein relative to an initial position where the bottom surface of the prism carrier is parallel to the base plate, an angle of rotation of the prism carrier relative to the base about the first rotation axis is less than or equal to 5°, and an angle of rotation of the prism carrier relative to the base about the second rotation axis is less than or equal to 5°.

9. A method for detecting a rotation angle of a prism motor, applied to a prism motor including:
a base, including a base plate;
a prism carrier, disposed above the base plate and configured to carry a prism, wherein the prism carrier is rotatable relative to the base about each of a first rotation axis and a second rotation axis, the first rotation axis and the second rotation axis are both parallel to a surface of the base plate, and an intersection point of the first rotation axis and the second rotation axis is a rotation center;
a first electrode plate, located on the surface of the base plate, wherein an orthographic projection of a geometric center of the first electrode plate on the base plate coincides with an orthographic projection of the rotation center on the base plate;
a plurality of second electrode plates, arranged at intervals on the surface of the base plate and spaced apart from the first electrode plate, wherein at least two second electrode plates of the plurality of second electrode plates are symmetrically arranged about a plane in which the geometric center of the first electrode plate and the first rotation axis are located; and
a floating electrode plate, located on a bottom surface of the prism carrier and disposed opposite to each of the first electrode plate and the plurality of second electrode plates;
wherein the first electrode plate and the plurality of second electrode plates are configured to connect to a detection circuit, a first capacitor is formed between the first electrode plate and the floating electrode plate, a second capacitor is formed between each respective second electrode plate of the plurality of second electrode plates and the floating electrode plate, and a capacitance value between the respective second electrode plate and the first electrode plate is a series capacitance value of the first capacitor and the second capacitor;
the method comprising:
rotating the prism carrier to an initial position where the bottom surface of the prism carrier is parallel to the base plate;
rotating the prism carrier clockwise about the first rotation axis to a first target angle, during rotation, acquiring a plurality of first capacitance values between each respective second electrode plate and the first electrode plate at a plurality of first rotation angles, and fitting a first curve graph with the plurality of first rotation angles and the plurality of first capacitance values;
rotating the prism carrier back to the initial position;
rotating the prism carrier counterclockwise about the first rotation axis to a second target angle, during rotation, acquiring a plurality of second capacitance values between the respective second electrode plate and the first electrode plate at a plurality of second rotation angles, and fitting a second curve graph with the plurality of second rotation angles and the plurality of second capacitance values;
combining the first curve graph and the second curve graph to obtain a capacitance-angle curve graph, the capacitance-angle curve graph characterizing a relationship between capacitance values between the respective second electrode plate and the first electrode plate and different angles to which the prism carrier is rotated about the first rotation axis relative to the base;
acquiring a real-time capacitance between the first electrode plate and the respective second electrode plate; and
inputting the real-time capacitance into the capacitance-angle curve graph to obtain a rotation angle of the prism carrier about the first rotation axis relative to the base.

10. The method according to claim 9, wherein at least two second electrode plates of the plurality of second electrode plates are symmetrically arranged about a plane in which the geometric center of the first electrode plate and the second rotation axis Y are located.

11. The method according to claim 9, wherein the first electrode plate includes:
a central electrode plate, wherein an orthographic projection of a geometric center of the central electrode plate on the base plate coincides with an orthographic projection of the rotation center on the base plate; and
a plurality of extension electrode plates, located around the central electrode plate and centrally symmetrically arranged about the geometric center of the central electrode plate, wherein each of the plurality of extension electrode plates is electrically connected to the central electrode plate;
wherein along a circumferential direction of the central electrode plate, a respective second electrode plate of the plurality of second electrode plates is between adjacent extension electrode plates of the plurality of extension electrode plates.

12. The method according to claim 9, wherein the first electrode plate includes a through-hole penetrating the first electrode plate in a thickness direction, an orthographic projection of a geometric center of the through-hole on the surface of the base plate coincides with the orthographic projection of the rotation center on the base plate, and the plurality of second electrode plates are located within the through-hole.

13. A camera device, comprising:
a prism motor, including:
a base, including a base plate;
a prism carrier, disposed above the base plate and configured to carry a prism, wherein the prism carrier is rotatable relative to the base about each of a first rotation axis and a second rotation axis, the first rotation axis and the second rotation axis are both parallel to a surface of the base plate, and an intersection point of the first rotation axis and the second rotation axis is a rotation center;
a first electrode plate, located on the surface of the base plate, wherein an orthographic projection of a geometric center of the first electrode plate on the base plate coincides with an orthographic projection of the rotation center on the base plate;
a plurality of second electrode plates, arranged at intervals on the surface of the base plate and spaced apart from the first electrode plate, wherein at least two second electrode plates of the plurality of second electrode plates are symmetrically arranged about a plane in which the geometric center of the first electrode plate and the first rotation axis are located; and
a floating electrode plate, located on a bottom surface of the prism carrier and disposed opposite to each of the first electrode plate and the plurality of second electrode plates;
a prism, disposed on the prism carrier, wherein an incident light direction of the prism is perpendicular to the surface of the base plate, and a reflected light direction of the prism is parallel to the first rotation axis;
a lens, having a focusing direction that coincides with the reflected light direction of the prism; and
a photosensitive chip, located on a side of the lens away from the prism and configured to receive reflected light passing through the lens.

14. The camera device according to claim 13, wherein at least two second electrode plates of the plurality of second electrode plates are symmetrically arranged about a plane in which the geometric center of the first electrode plate and the second rotation axis Y are located.

15. The camera device according to claim 13, wherein the first electrode plate includes:
a central electrode plate, wherein an orthographic projection of a geometric center of the central electrode plate on the base plate coincides with an orthographic projection of the rotation center on the base plate; and
a plurality of extension electrode plates, located around the central electrode plate and centrally symmetrically arranged about the geometric center of the central electrode plate, wherein each of the plurality of extension electrode plates is electrically connected to the central electrode plate;
wherein along a circumferential direction of the central electrode plate, a respective second electrode plate of the plurality of second electrode plates is between adjacent extension electrode plates of the plurality of extension electrode plates.

16. The camera device according to claim 13, wherein the first electrode plate includes a through-hole penetrating the first electrode plate in a thickness direction, an orthographic projection of a geometric center of the through-hole on the surface of the base plate coincides with the orthographic projection of the rotation center on the base plate, and the plurality of second electrode plates are located within the through-hole.

17. The camera device according to claim 13, wherein the plurality of second electrode plates are located at a periphery of the first electrode plate.

18. The camera device according to claim 13, wherein an orthographic projection of each of the first electrode plate and the plurality of second electrode plates on the surface of the base plate is within an orthographic projection of the floating electrode plate on the surface of the base plate.

19. The camera device according to claim 13, wherein the floating electrode plate includes a plurality of conductive plates, the plurality of conductive plates are electrically connected to each other, and an orthographic projection of each respective conductive plate of the plurality of conductive plates on the surface of the base plate covers the first electrode plate or one respective second electrode plate of the plurality of second electrode plates.

20. The camera device according to claim 13, wherein relative to an initial position where the bottom surface of the prism carrier is parallel to the base plate, an angle of rotation of the prism carrier relative to the base about the first rotation axis is less than or equal to 5°, and an angle of rotation of the prism carrier relative to the base about the second rotation axis is less than or equal to 5°.
